(19) United States
(12) Patent Application Publication
(10) Pub. No.: US 2026/0322766 A1
(43) Pub. Date: Oct. 15, 2026

(54) Configurable network on chip

(71) Applicant: SANECHIPS TECHNOLOGY CO., LTD., Shenzhen, (CN)

(72) Inventors: Zhicheng WEN, Shenzhen (CN); KE XU, Shenzhen (CN); Fang ZHU, Shenzhen (CN)

(21) Appl. No.: 19/485,710

(22) PCT Filed: Jul. 30, 2024
(86) PCT No.: PCT/CN2024/108462

§ 371 Date: Nov. 19, 2025

(30) Foreign Application Priority Data
Aug. 15, 2023 (CN) 202311026782.1

(51) Int. Cl. H04L 49/109

(52) U.S. Cl. CPC H04L 49/109

(57) ABSTRACT

Embodiments of the present disclosure provide a configurable network on chip. The configurable network on chip include at least one sub-network of k-ary and n-dimensional nodes, wherein the nodes of the network on chip are connected through network links, a selector is provided between the adjacent nodes, and the selector controls the connection and disconnection of all network links in the sub-network and all network links between the sub-networks, so as to configure the topology structure of the network on chip. In this way, a topology structure of an network on chip can be flexibly configured according to a task requirement, so that the network on chip has good extendibility, thereby solving a problem that an existing network on chip topology structure has a large transmission delay and a single transmission path in a complex task scenario.

### CROSS-REFERENCE TO RELATED APPLICATION

This disclosure is a national stage filing under 35 U.S.C. § 371 of international application number PCT/CN 2024/108462, filed Jul. 30, 2024, which based on Chinese Patent Application CN 202311026782.1, filed on Aug. 15, 2023 and entitled “Configurable network on chip”, and claims the priority to the disclosure, which is incorporated in its entirety herein by reference.

### TECHNICAL FIELD

Embodiments of the present disclosure relate to the field of communications, and in particular, to a configurable network on chip.

### BACKGROUND

A Neuralnetwork Processing Unit (NPU) is a very representative many-core architecture at present, has a wide application prospect, and is very promising in the future. However, the traditional communication method limits the communication bandwidth of the NPU, the number of cores, and the expandability. After a Network on Chip (NoC) is introduced into the NPU as a bus interconnection architecture, the limitation of the communication bandwidth is greatly alleviated, facilitating the increase and expansion of the NPU core.

However, with the increase of the core number of the NPU, in a complex task scenario, an existing network on chip topology structure has problems such as a single transmission path and a large transmission delay.

### SUMMARY

Embodiments of the present disclosure provide a configurable network on chip, so as to at least solve the problems in the related art that an existing network on chip topology structure has a single transmission path and a large transmission delay in a complex task scenario.

According to an embodiment of the present disclosure, a configurable network on chip is provided, wherein the network on chip includes at least one sub-network of k-ary and n-dimensional nodes; nodes of the network on chip are connected through network links; a selector is connected between two adjacent nodes;

The selector is configured to configure a topology structure of the network on chip by controlling connectivity of all network links of the network on chip.

In an embodiment, the sub-network includes pier nodes, and pier nodes of different sub-networks are connected through the network links.

In an embodiment, the network on chip further includes bridge nodes, and the bridge nodes are located between the sub-network; wherein each of the pier nodes is connected to one of the bridge nodes, and a plurality of adjacent pier nodes are connected to the same bridge node.

In an embodiment, a plurality of bridge nodes are connected through the network links; the selector is connected between adjacent bridge nodes.

In an embodiment, the network links include at least one of the following categories: mesh links, ring links, configurable links.

In an embodiment, two ends of the configurable links are respectively connected to different selectors; the configurable links are cross-node links, and two ends of the configurable links are configured to cross one or more nodes.

In an embodiment, the selector is further configured to select one of the network links to be connected in the case that a plurality of the network links are connected.

In an embodiment, the bridge nodes in the same row or the same column are connected through the ring links.

In an embodiment, the topology structure of the network on chip includes an intra-sub-network topology structure and an inter-sub-network topology structure, and the intra-sub-network topology structure and the inter-sub-network topology structure are configured with different routing algorithms; wherein the inter-sub-network topology structure is a topology structure formed by connecting a plurality of bridge nodes through the network links.

In an embodiment, the bridge nodes are configured with inter-sub-network routing algorithms in accordance with the inter-sub-network topology structure.

In an embodiment, the sub-network further includes non-pier nodes, and the non-pier nodes in the intra-sub-network topology structure and the pier nodes in the intra-sub-network topology structure are configured with different routing algorithms.

In an embodiment, the non-pier nodes are configured with a relabeling algorithm, and the pier nodes are configured with a fused routing algorithm of an inter-sub-network routing algorithms and the relabeling algorithm.

### BRIEF DESCRIPTION OF THE DRAWINGS

FIG. 1 is a diagram of a configurable network on chip architecture according to an embodiment of the disclosure;

FIG. 2 is a schematic diagram of a configurable heterogeneous sub-network according to an embodiment of the present disclosure;

FIG. 3 is a schematic diagram of a sub-network configured as a ring topology structure according to an embodiment of the present disclosure;

FIG. 4 is a schematic diagram of a sub-network configured as a mesh topology structure according to an embodiment of the present disclosure;

FIG. 5 is a schematic diagram of a sub-network configured as a cmesh topology structure according to an embodiment of the present disclosure;

FIG. 6 is a schematic diagram of a sub-network configured as a torus topology structure according to an embodiment of the present disclosure;

FIG. 7 is a schematic diagram of a sub-network configured as a tree topology structure according to an embodiment of the present disclosure;

FIG. 8 is a schematic diagram of a sub-network configured as a hypercube topology structure according to an embodiment of the present disclosure;

FIG. 9 is a schematic diagram showing the global integration of a 2×2 heterogeneous sub-network according to an embodiment of the present disclosure;

FIG. 10 is a schematic diagram showing the global integration of a 2×4 heterogeneous sub-network according to an embodiment of the present disclosure;

FIG. 11 is a schematic diagram showing the global integration of a 4×4 heterogeneous sub-network according to an embodiment of the present disclosure;

FIG. 12 is a schematic diagram of intra-network routing numbers according to an embodiment of the present disclosure.

### DETAILED DESCRIPTION OF THE EMBODIMENTS

Embodiments of the present disclosure will be described below in detail with reference to the accompanying drawings and in conjunction with embodiments.

It should be noted that, terms such as “first” and “second” in the description, claims, and accompanying drawings of the present disclosure are used to distinguish similar objects, but are not necessarily used to describe a specific sequence or order.

A Network on Chip (NoC) borrows a communication manner of a distributed computing system, adopts a routing and packet switching technology to replace a traditional bus, and is a new method for solving a complex on-chip communication problem. The NoC technology solves three inherent problems of bus architecture: scalability problems due to limited address space, communication efficiency problems due to time-division communication, and power consumption and area problems due to global synchronization.

The key technology of the network on chip lies in that:

Topology structure: the topology structure of the network on chip is the arrangement of the communication node elements, and the ability of the network on chip to effectively propagate depends largely on the underlying topology structure.

A routing algorithm: the routing algorithm establishes a path to be executed for each message or packet, and searches for a path satisfying a certain limit on data transmission on a network on chip structure.

Currently, network on chips mainly have three types of topology structures: mesh, torus, and tree, and a routing algorithm mainly adopts an XY-dimensional routing algorithm. A topology structure proposed in the prior art is designed for a certain type of specific application, and does not have a feature of being configurable according to an application task. In addition, a corresponding routing algorithm is designed for a specific topology, and does not have the capability for routing of multiple topologies.

Proposed by a Network on chip (NoC) is mainly used for solving a communication problem in a multi-core/many-core architecture. A topology structure and a routing algorithm are key points of an NoC technology. A suitable topology structure and routing algorithm greatly improve a communication capability between multi-cores/many-core. After the NoC is introduced into an NPU as a bus interconnection architecture, the limitation of communication bandwidth will be greatly alleviated, facilitating the increase and expansion of an NPU core.

However, with the increase of the core number of the NPU, the existing topology structure has a problem of a large transmission delay and a single transmission path. Furthermore, the network connection of the NPU is diversified and has a huge amount of data, and a certain communication problem is easily caused by connections of a single topology structure, such as mesh and torus.

The technical idea of the present disclosure is to select a network element of k-ary and n-dimensional nodes as a sub-network of an network on chip, an network on chip may be composed of one or more sub-networks, and nodes of the network on chip are connected through network links, a selector is set between nodes in each sub-network, and a selector is set between nodes in a sub-network, the selector controls the connection and disconnection of all network links in the sub-network and all network links between the sub-networks, configuring a topology structure of the network on chip. in this way, a topology structure of an network on chip can be flexibly configured according to a task requirement, so that the network on chip has good extendibility, thereby solving a problem that an existing network on chip topology structure has a large transmission delay and a single transmission path in a complex task scenario.

The embodiments of the present disclosure support a communication task of a multi-core/many-core system, and are applicable to an intelligent AI accelerating application environment such as a service class and a communication class, and include, but are not limited to, scenarios such as a data center, automatic driving, virtual money, and a terminal AI.

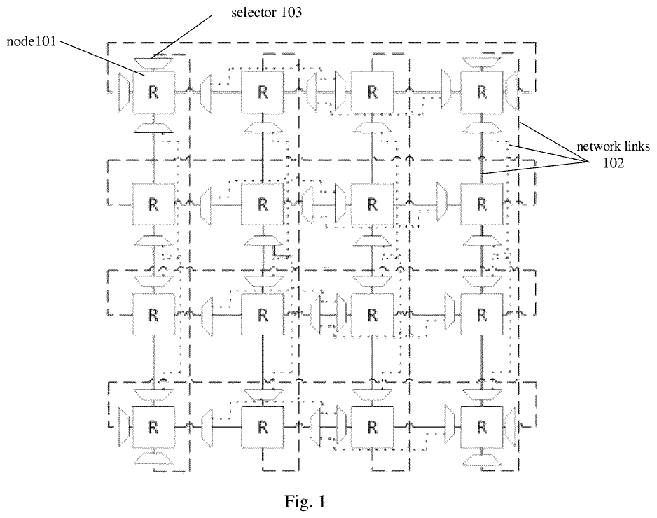

FIG. 1 is a structural diagram of a configurable network on chip according to an embodiment of the present disclosure. The network on chip includes at least one sub-network 10 with k-ary and n-dimensional nodes. As shown in FIG. 1, taking an embodiment in which the network on chip includes a 4-ary and 2-dimensional (i.e. 4×4) sub-network 10, nodes 101 of the network on chip are connected through a network link 102; a selector 103 is connected between two adjacent nodes; the selector is configured to configure a topology structure of the network on chip by controlling connectivity of all network links of the network on chip.

The network on chip technology is a process of converting data transmission between IP cores into data forwarding between routers. The nodes on the network on chip may include a processing unit node and a Router node, and a router may be connected to a processing unit. In an embodiment of the present disclosure, a Router node is taken as a node on a sub-network for description.

K is the number of nodes on each sub-network edge, for example, a 4×4 grid mesh sub-network and a 4-ary and 2-dimensional torus sub-network both are 16 nodes in total.

In an embodiment, a 4×4 sub-network 10 may be established first, nodes 101 in the sub-network 10 are connected through a network link 102. On this basis, a selector 103 may be added, the selector 103 is disposed between each adjacent node 101, and the selector 103 is connected to the adjacent node 101 through the network link 102.

In an embodiment, the selector 103 may control the network link 102, so as to control input and output of the node.

The selector 103 in this embodiment may switch on or off all links in the sub-network in real time according to application requirements, so as to implement the heterogeneity of the sub-networks.

It should be noted that, the described sub-network with 4×4 size is only an example, and sub-networks with other sizes, such as 3×3, 5×5, etc., may also be used in the heterogeneous method, which is not limited in the embodiment of the present disclosure.

In an embodiment, the network links include at least one of the following categories: mesh links, ring links, configurable links.

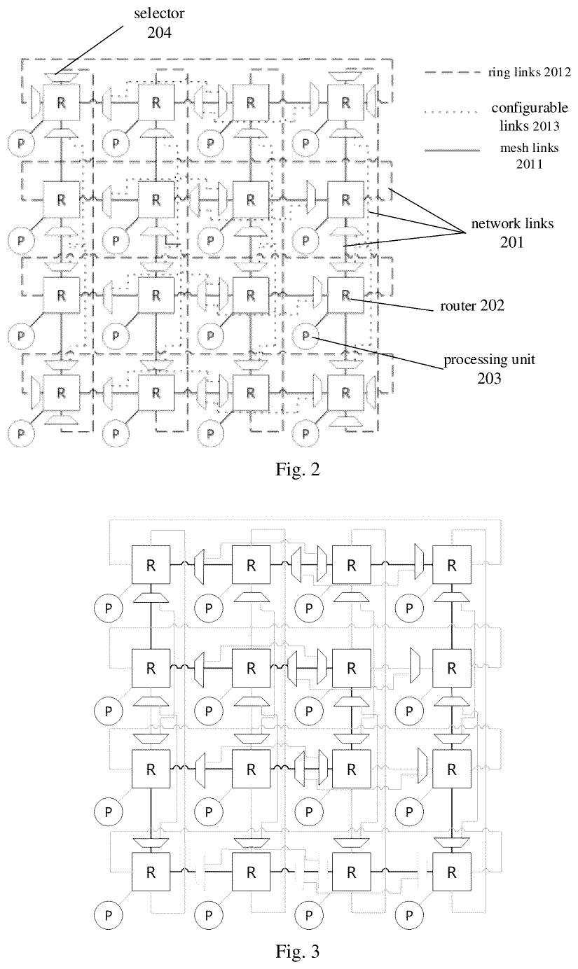

In an embodiment, FIG. 2 is a schematic diagram of a configurable heterogeneous sub-network according to an embodiment of the present disclosure. Referring to FIG. 2, the sub-network includes a network link 201, a router 202, a processing unit 203, a Network Interface (NI) (not shown in the figure), and a selector 204. The network links 201 may include at least the following three link structures: a mesh link 2011, a ring link 2012, and a configurable link 2013.

In an embodiment, a mesh link 2011 is a link in a transverse direction and a longitudinal direction of a router; a ring link 2012 is a link between a sub-network edge node and an edge node; and a configurable link 2013 is a link added for increasing the topology variability, and is a cross-node link.

In an embodiment, two ends of the configurable link 2013 are respectively connected to different selectors; the configurable link 2013 is a cross-node link, and two ends of the configurable link 2013 are configured to cross one or more nodes.

In an embodiment, two ends of the configurable link 2013 may be connected to different selectors respectively, and the configurable link 2013 may span one or more nodes according to a size of a sub-network. Configurable link 2013 may be the same selector as the mesh link 2011 and the ring link 2012 in the same direction of part of the nodes.

In an embodiment, the selector 204 is further configured to select one of the network links 202 to be connected if a plurality of the network links 202 are connected.

In an embodiment, in a case that the selector is connected to a plurality of network links, a proper network link may be selected for connection according to an actual application scenario, so as to reduce a technical problem of large transmission delay. As shown in FIG. 2, one end of the selector 204 is connected to the router 202 through one network link 201, and the other end is connected to different routers respectively through two network links 201. One of the two network links 201 connected to the selector 204 may be a configurable link 2013. The configurable link 2013 may be connected to another selector across a node. When the selector selects to connect to the configurable link 2013, the sub-network may implement cross-node communication.

In an embodiment, in a sub-network, a selector may control the connection and disconnection of network links between nodes in the sub-network, so as to implement heterogeneous sub-networks. For example, the topology structure within a sub-network can be configured by the selector to be a ring structure, mesh structure, concentrated mesh structure (cmesh), torus structure, tree structure, hypercube structure, and other irregular topologies, among others.

The heterogeneity of sub-networks is further illustrated below by some examples:

### Embodiment 1

FIG. 3 is a schematic diagram of a sub-network configured as a ring topology structure according to an embodiment of the present disclosure, and as shown in FIG. 3, the gray links represent disabled links, while the black links represent enabled links. The selector only needs to control the mesh links to be opened to configure a ring topology structure.

### Embodiment 2

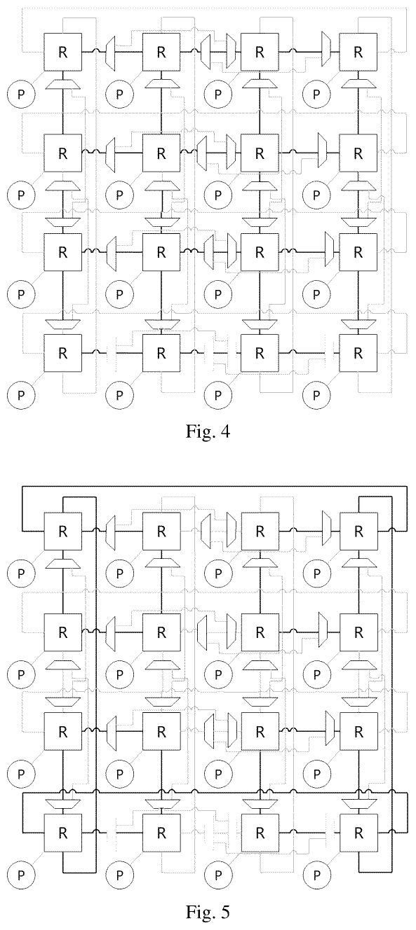

FIG. 4 is a schematic diagram of a sub-network configured as a mesh topology structure according to an embodiment of the present disclosure. As shown in FIG. 4, the gray links represent disabled links, while the black links represent enabled links. The selector only needs to control the activation of certain mesh links to configure the mesh topology structure.

### Embodiment 3

FIG. 5 is a schematic diagram of a sub-network configured as a cmesh topology structure according to an embodiment of the present disclosure. As shown in FIG. 5, the gray links represent disabled links, while the black links represent enabled links, and for convenience of expanding a topology structure, a corner node of a sub-network may be selected as a centralized node of the cmesh type, and a selector only needs to control opening of a part mesh link and a ring link so as to be configured as the topology structure of the cmesh type.

### Embodiment 4

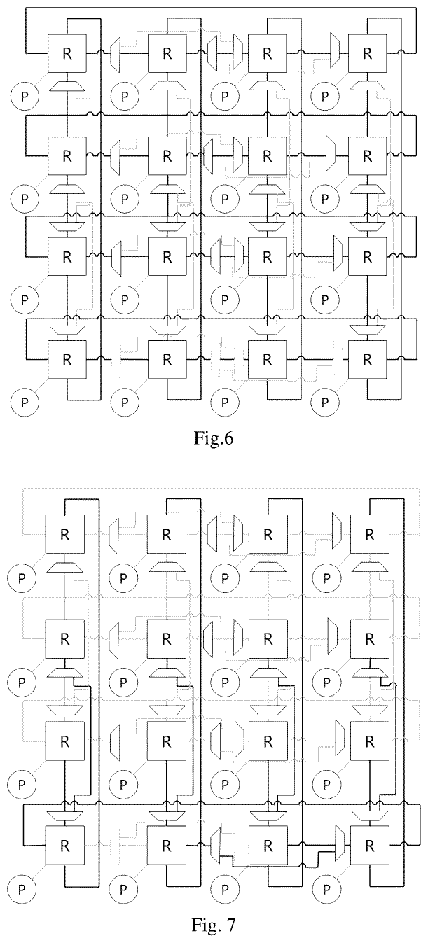

FIG. 6 is a schematic diagram of a sub-network configured as a torus topology structure according to an embodiment of the present disclosure. As shown in FIG. 6, the gray links represent disabled links, while the black links represent enabled links, and a selector only needs to control opening of a mesh link and a ring link so as to be configured as a torus topology structure.

### Embodiment 5

FIG. 7 is a schematic diagram of a sub-network configured as a tree topology structure according to an embodiment of the present disclosure. As shown in FIG. 7, the gray links represent disabled links, while the black links represent enabled links, and in order to facilitate the expansion of a topology, a corner node of a sub-network may be selected as a root node of a tree topology, the selector only needs to control the mesh link, the ring link and the configurable link to open so as to configure the tree topology structure, the root node of the tree topology may be selected according to a requirement of horizontal expansion.

### Embodiment 6

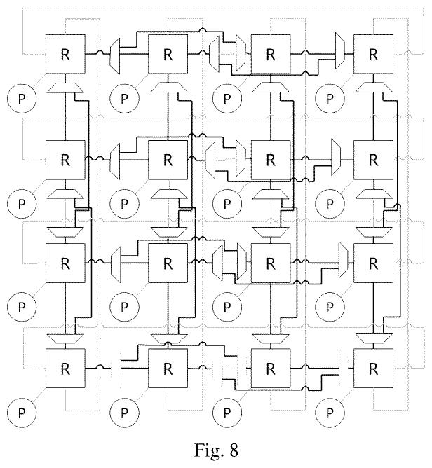

FIG. 8 is a schematic diagram of a sub-network configured as a hypercube topology structure according to an embodiment of the present disclosure. As shown in FIG. 8, the gray links represent disabled links, while the black links represent enabled links, and a selector can be configured as a supercube-type topology structure only by controlling a part of mesh link and enabling a configurable link.

The embodiments of the present disclosure increase the variability of the topology structure of an network on chip by adding a selector and a part of configurable links, can be configured into a desired topology structure according to an application scenario, and can also be custom-defined according to a user, greatly improving the type and range of the configurable topology structure, and having advantages over a single-type topology in terms of execution performance of different applications.

In addition, in terms of a hierarchical topology structure global topology integration method, a plurality of topologies may be selected as hierarchical topologies, and a sub-network may also be directly connected for communication.

In an embodiment, the sub-networks include pier nodes, and pier nodes of different sub-networks are connected through the network links.

In an embodiment, nodes in a sub-network may be classified into pier nodes and non-pier nodes, pier nodes of different sub-networks are connected through a network link, and different sub-networks communicate with each other through the pier nodes.

In an embodiment, the pier node may be selected according to the processing capability or the amount of tasks required to be processed of a node in the sub-network, for example, if the processing capability of a corner node in the sub-network is high and the amount of tasks required to be processed is small, the corner node may be selected as the pier node for communication across the sub-network.

It should be noted that, the described selection of a corner node in a sub-network as a pier node is merely an embodiment of the present disclosure, and a person skilled in the art may select any node in a sub-network as a pier node according to actual situations, and the embodiments of the present disclosure are not limited thereto.

In an embodiment, the network on chip further includes a bridge node, wherein the bridge node is located between sub-networks; wherein each of the pier nodes is connected to one of the bridge nodes, and a plurality of adjacent pier nodes are connected to the same bridge node.

In embodiments of the present disclosure, different sub-networks may communicate with each other directly through respective pier nodes, or a bridge node is added between the sub-networks to establish a connection between adjacent pier nodes through the bridge node. A person skilled in the art would have been able to choose to add a bridge node according to practical task scenarios.

In an embodiment, in order to guarantee the minimum number of communication hops between sub-networks and reduce competition, a bridge node may be added outside the sub-networks to be responsible for communication between the sub-networks, a node connected to the bridge node is a pier node, each pier node may be connected to one bridge node, and a plurality of adjacent pier nodes may be connected to the same bridge node.

In an embodiment, a plurality of bridge nodes are connected through the network link; the selector is connected between adjacent bridge nodes.

In an embodiment, there may be a plurality of bridge nodes, the plurality of bridge nodes may be connected through network links, and a selector is connected between adjacent bridge nodes. The selector can configure the topology structure between the sub-networks by controlling the connection and disconnection of the network links between the bridge nodes. For example, the degrees of the bridge node and the pier node can both be set as 5, and redundant links can be connected by a selector.

In an embodiment, the topology structure among the bridge nodes between the sub-networks can select a structure topology such as mesh, torus or tree according to the number of the sub-networks, and the topology structure among the bridge nodes can also be customized, and the links in the configurable network on chip topology can be increased or decreased appropriately according to application requirements, which is not limited in this example.

In an embodiment, the heterogeneous sub-network may be extended to different size network on chips by means of global integration of the heterogeneous sub-network. The heterogeneous sub-network global integration is further illustrated below by some examples:

### Embodiment 7

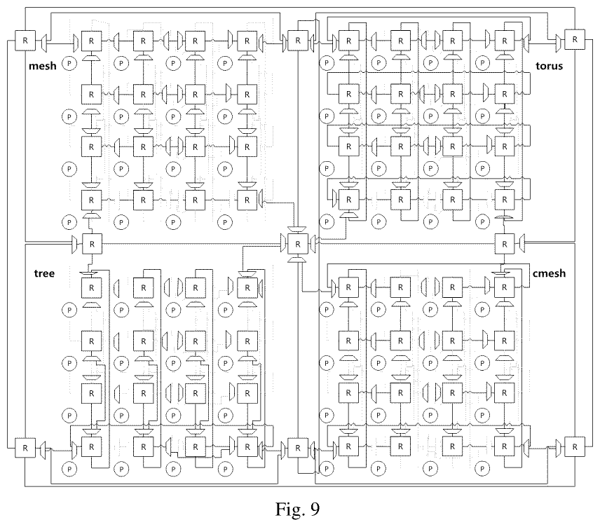

FIG. 9 is a schematic diagram showing the global integration of a 2×2 heterogeneous sub-network according to an embodiment of the present disclosure. Referring to FIG. 9, corner nodes of each sub-network are used as pier nodes, adjacent pier nodes among the sub-networks are connected through a bridge node, and each sub-network may be a different topology structure. As shown in FIG. 9, topology structures of the sub-network from left to right and from top to bottom are mesh, torus, tree, and cmesh in sequence. Bridge nodes between sub-networks are connected through a ring link.

FIG. 9 horizontally extends four 4×4 sub-networks into an 8×8 network on chip, where the network on chip includes four intra-sub-network topologies and one 3×3 inter-sub-network topology.

### Embodiment 8

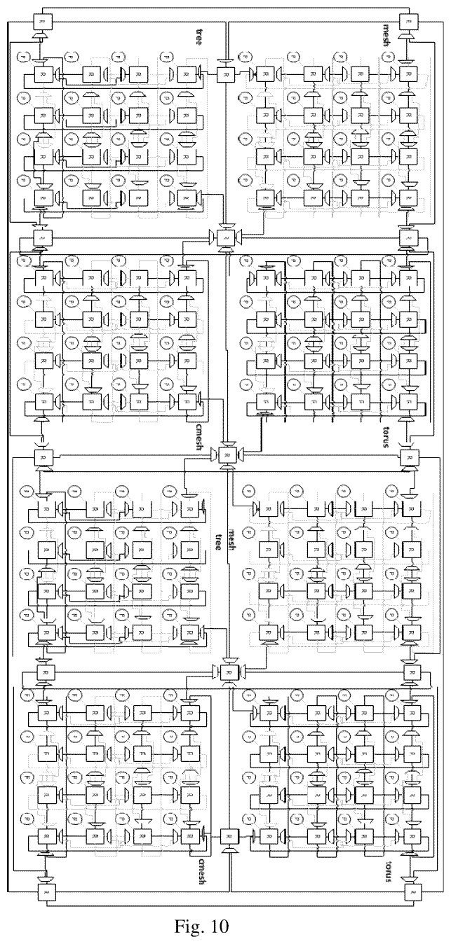

FIG. 10 is a schematic diagram showing the global integration of a 2×4 heterogeneous sub-network according to an embodiment of the present disclosure. Referring to FIG. 10, corner nodes of each sub-network are used as pier nodes, adjacent pier nodes among the sub-networks are connected through a bridge node, and each sub-network may be of different topology structures. As shown in FIG. 10, the topology structures of the sub-network from left to right and from top to bottom are mesh, torus, mesh, torus, tree, cmesh, tree, cmesh in sequence. Bridge nodes between sub-networks are connected through a ring link.

FIG. 10 horizontally extends eight 4×4 sub-networks to an 8×16 network on chip, where the network on chip includes eight intra-sub-network topologies and one 3×5 inter-sub-network topology.

### Embodiment 9

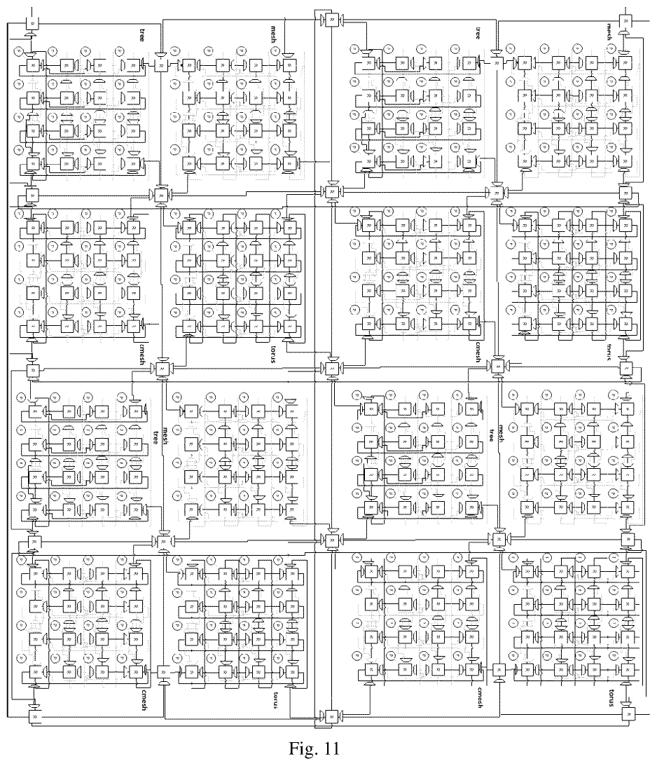

FIG. 11 is a schematic diagram showing the global integration of a 4×4 heterogeneous sub-network according to an embodiment of the present disclosure. Referring to FIG. 11, a corner node of each sub-network is used as a pier node, adjacent pier nodes between sub-networks are connected through a bridge node, and each sub-network may be of different topological structures, as shown in FIG. 11, the topologies of the sub-network from left to right and from top to bottom are mesh, torus, mesh, torus, tree, cmesh, tree, cmesh, mesh, torus, mesh, torus, tree, cmesh, tree, cmesh. Bridge nodes between sub-networks are connected through a ring link.

In FIGS. 11, 16 4×4 sub-networks are horizontally and vertically extended to 16×16 network on chips, and the network on chips include 16 intra-sub-network topologies and 1 5×5inter-sub-network topologies.

That is, the global integration is a connection based on a sub-network, and a pier node capable of communicating across the sub-network may be selected in the sub-network first, a bridge node capable of communication is added between the sub-networks, and the bridge node is connected to a pier node in a corresponding sub-network, a topology structure may be selected from bridge nodes between sub-networks for connection, for example, a topology structure mesh, a topology structure torus, or the like may be selected for connection, thus, an extended network on chip is obtained.

In an embodiment, the bridge nodes in a same row or a same column are connected through the ring link.

In an embodiment, when four or eight 4×4 sub-network topologies are expanded in the transverse direction, in order to guarantee the minimum number of communication hops between the sub-networks and equal support for a plurality of topologies, the corner nodes of the sub-networks may be selected as pier nodes, bridge nodes are added outside the pier nodes, and bridge nodes may be connected in a ring topology between the same row or the same column.

In an embodiment, the topology of the network on chip includes an intra-sub-network topology and an inter-sub-network topology, the intra-sub-network topology and the inter-sub-network topology being configured with different routing algorithms; wherein the inter-subnet topology structure is a topology structure formed by connecting a plurality of bridge nodes through the network links.

In an embodiment, the topology structure of the network on chip may comprise an intra-sub-network topology structure and an inter-sub-network topology structure, and the intra-sub-network topology structure and the inter-sub-network topology structure are configured with different routing algorithms.

Wherein the topology structure among the sub-networks is a topology structure formed by connecting a plurality of bridge nodes through network links; the topological structure in the sub-network is a topological structure formed by connecting nodes in a plurality of sub-networks through network links.

In an embodiment, the bridge nodes are configured with inter-sub-network routing algorithms in accordance with the inter-sub-network topology.

In an embodiment, an inter-sub-network routing algorithm may be configured for the bridge node between the sub-networks according to the topology structure between the sub-networks. For example, the inter-subnet routing algorithm is a deterministic routing algorithm (for example, an xy-dimensional routing algorithm), the topology structure of the inter-subnet is a mesh structure, then a source address and a target address can be determined according to the mesh structure, and corresponding coordinates are configured for each bridge node in the mesh structure.

In an embodiment, the inter-sub-network routing algorithm may also be a sub-network isolation function.

In an embodiment, the sub-network further comprises non-pier nodes, and the non-pier nodes in the topology structure in the sub-network and the pier nodes in the topology structure in the sub-network are configured with different routing algorithms.

In an embodiment, a non-pier node in a topology structure in a sub-network does not directly participate in cross-network node communication, and the pier node not only participates in intra-sub-network communication, but also participates in inter-sub-network communication with a bridge node; therefore, the non-pier node and the pier node can be configured with different routing algorithms.

In an embodiment, the non-pier nodes are configured with a relabeling algorithm, and the pier nodes are configured with a fused routing algorithm of an inter-sub-network routing algorithms and the relabeling algorithm.

In an embodiment, a label relabeling algorithm may be configured for a non-pier node, and a convergence routing algorithm of a sub-network routing algorithm and a relabeling algorithm may be configured for a pier node, that is, a relabeling algorithm may be adopted in a sub-network.

In an embodiment, since a routing algorithm determines a routing direction according to a routing number, when a topology structure changes, a relabeling algorithm may rearrange a routing number according to a new topology structure and synchronously configure same in each routing node, and then the routing algorithm performs routing according to the new number, so that conversion between a physical ID and a virtual ID is realized, and routing of a plurality of topologies is facilitated, and the realization is simple and costs are low.

Routing algorithms within a sub-network are further illustrated by an embodiment below:

### Embodiment 10

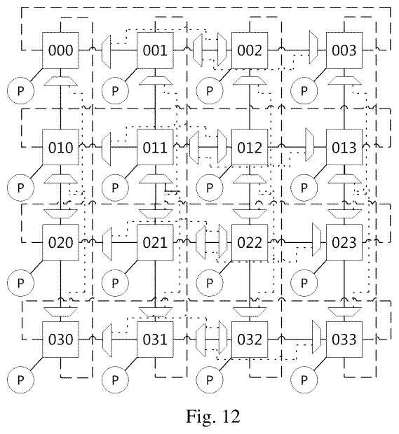

FIG. 12 is a schematic diagram of intra-network routing numbers according to an embodiment of the present disclosure. A starting routing number in a sub-network is as shown in FIG. 12, and numerical numbers respectively represent three dimensions z, y and x, wherein y and x are self-network routing numbers, and z is an inter-sub-network routing number. Numbers 000, 003, 030 and 033 may be selected as intra-sub-network pier nodes, and other nodes may be selected as non-pier nodes in the sub-network. A source node and a target node may be selected according to an application scenario, and are routed from the source node to the target node according to a serial number on the node; when the topology structure is switched, the routing algorithm configured on the node may change a corresponding signal to adapt to a new topology structure, so as to implement a function that the topology structure is configured in real time while the routing algorithm is unchanged.

In the embodiments of the present disclosure, one set of routing algorithm may be used in a sub-network to solve the communication problem of a plurality of routing heterogeneous sub-networks, so that the cost is low and the realizability is high.

In the embodiments, the configurable network on chip of the present disclosure may include one or more sub-networks of k-ary and n-dimensional nodes, the nodes of the network on chip are connected through network links, a selector is provided between adjacent nodes, and all network links in the sub-network and all network links between the sub-networks are controlled to be connected or disconnected through the selector, so as to configure the topology structure of the network on chip. In this way, a topology structure of an network on chip can be flexibly configured according to a task requirement, so that the network on chip has good extendibility, thereby solving a problem that an existing network on chip topology structure has a large transmission delay and a single transmission path in a complex task scenario.

The foregoing descriptions are merely exemplary embodiments of the present disclosure, but are not intended to limit the present disclosure. For those skilled in the art, the present disclosure may have various modifications and variations. Any modifications, equivalent replacements, improvements and the like made within the principle of the present disclosure shall fall within the scope of protection of the present disclosure.

1. A configurable network on chip, wherein the network on chip comprises at least one sub-network of k-ary and n-dimensional nodes; the nodes of the network on chip are connected through network links; a selector is connected between two adjacent nodes;
the selector is configured to configure a topology structure of the network on chip by controlling connectivity of all the network links of the network on chip.

2. The configurable network on chip according to claim 1, wherein the sub-network comprises pier nodes, and the pier nodes of different sub-networks are connected through the network links.

3. The configurable network on chip according to claim 2, wherein the network on chip further comprises bridge nodes, and the bridge nodes are located between the sub-network; wherein each of the pier nodes is connected to one of the bridge nodes, and a plurality of adjacent pier nodes are connected to the same bridge node.

4. The configurable network on chip according to claim 3, wherein a plurality of the bridge nodes are connected through the network links; the selector is connected between adjacent bridge nodes.

5. The configurable network on chip according to claim 1, wherein the network links comprises at least one of the following types: mesh links, ring links, and configurable links.

6. The configurable network on chip according to claim 5, wherein two ends of the configurable links are respectively connected to different selectors; the configurable links are cross-node links, and two ends of the configurable links are configured to cross one or more nodes.

7. The configurable network on chip according to claim 6, wherein the selector is further configured to select one of the network links to be connected in the case that a plurality of the network links are connected.

8. The configurable network on chip according to claim 5, wherein the bridge nodes in a same row or a same column are connected through the ring links.

9. The configurable network on chip according to claim 4, wherein the topology structure of the network on chip comprises an intra-sub-network topology structure and an inter-sub-network topology structure, and the intra-sub-network topology structure and the inter-sub-network topology structure are configured with different routing algorithms; wherein the inter-sub-network topology structure is a topology structure formed by connecting a plurality of bridge nodes through the network links.

10. The configurable network on chip according to claim 9, wherein the bridge nodes are configured with inter-sub-network routing algorithms in accordance with the inter-sub-network topology structure.

11. The configurable network on chip according to claim 9, wherein the sub-network further comprises non-pier nodes, and the non-pier nodes in the intra-sub-network topology structure and the pier nodes in the intra-sub-network topology structure are configured with different routing algorithms.

12. The configurable network on chip according to claim 11, wherein the non-pier nodes are configured with a relabeling algorithm, and the pier nodes are configured with a fused routing algorithm of an inter-sub-network routing algorithms and the relabeling algorithm.

13. The configurable network on chip according to claim 1, wherein the nodes on the network on chip comprise a processing unit node and a Router node.

14. The configurable network on chip according to claim 5, wherein the mesh links are links in a transverse direction and a longitudinal direction of a router.

15. The configurable network on chip according to claim 5, wherein the ring links are links between the sub-network edge node and an edge node.

16. The configurable network on chip according to claim 5, wherein the configurable links are links added for increasing the topology structure variability.

17. The configurable network on chip according to claim 5, wherein the configurable links span one or more nodes according to a size of the sub-network.

18. The configurable network on chip according to claim 2, wherein the pier nodes comprise corner nodes in the sub-network.

19. The configurable network on chip according to claim 12, wherein the inter-sub-network routing algorithms comprises sub-network isolation function.
